(19) United States
(12) Patent Application Publication
(10) Pub. No.: US 2004/0053419 A1
(43) Pub. Date: Mar. 18, 2004

(54) Test device

(76) Inventor: Gerrit Dirk Keizer, Bv Harderwijk (NL)

Correspondence Address: Kate H Murashige, Morrison & Foerster, Suite 500, 3811 Valley Centre Drive, San Diego, CA, 92130-2332, US

(21) Appl. No.: 10/466,367

(22) PCT Filed: Jan. 9, 2002
(86) PCT No.: PCT/EP02/00437

(30) Foreign Application Priority Data
Jan. 15, 2001 (EP) 01200146.7

(51) Int. Cl. G01N 31/22

(52) U.S. Cl. 436/169; 422/56; 422/61

(57) ABSTRACT

The present invention describes a test device which comprises a test strip and a sample receiving means having a predetermined volume. In a preferred test device two more test strips are present which are positioned parallel to each other.

### FIELD OF THE INVENTION

The present invention relates to a test device for determining the presence, absence or amount of an analyte in a liquid test sample.

### BACKGROUND OF THE INVENTION

Test strips are used for the detection of analytes in liquid samples such as urine, blood, milk, meat juice, etc. in the diagnostic field.

The analytes to be detected can be hormones, glucose, antibiotics, etc.

In general, the test devices based on strip technology have liquid sample receiving means to which a certain amount (e.g. a fixed number of drops) of liquid has to be added or which is dipped (for a limited time interval or otherwise) into the liquid sample.

For the first mentioned devices care has to be taken to ensure that the correct amount of liquid is added. Moreover, in many cases the test strip is surrounded by a plastic housing which makes the device expensive and, as such a device can not be reused results in the generation of a lot of waste.

For the second group of devices, where the strip is dipped into the liquid, care has to be taken that the liquid level is not too high to avoid wetting too much of the dipstick or that the level of the liquid is not too low, which might result in a too small amount of the sample being absorbed on the test strip.

### SUMMARY OF THE INVENTION

The device according to the invention potentially solves some or all of the problems mentioned above. The amount of sample liquid is less critical and moreover the test device is simple and inexpensive.

The present invention provides a test device for determining the presence, absence or amount of an analyte in a liquid test sample which comprises:

I at least one teststrip comprising at least:

a sample receiving zone;

a reaction zone; and,

an indication zone,

the teststrip comprising a material which makes transport of the analyte from the sample receiving zone, preferably via the reaction zone, to the indication zone, possible and in which, the analyte, if present, is directly or indirectly detectable in the indication zone; and

II a sample receiving means which is in functional connection with the sample receiving zone of the teststrip, so that when the sample is added to the receiving means the liquid sample is in liquid contact with the sample receiving zone and the sample receiving means will receive no more liquid than a predetermined quantity,

wherein when the device is placed on a horizontal plane the teststrip makes an angle of from 10 to 90° with the horizontal plane.

The present invention also provides a kit comprising:

a teststrip as defined in any one of the preceding claims;

a sample receiving means of the invention; and

packaging.

The present invention further provides for the use of a test device or test of the invention to determine the presence, absence or amount of an analyte.

The present invention also provides a method for detecting the presence, absence or amount of an analyte in a liquid test sample, comprising:

adding the test sample to the sample receiving means of a test-device of the invention;

identifying, and optionally quantifying, any detectable change in the indication zone of the test-strip of the device.

### BRIEF DESCRIPTION OF THE FIGURES

FIG. 1 shows an example of a test strip according to the invention

FIG. 2 shows a test device having two test strips

FIG. 3 shows the side view of the cross section test device of FIG. 2

FIG. 4 shows a test device having two test strips

FIG. 5 shows the side view of the cross section test device of FIG. 4

FIG. 6 shows the side view of the cross section on a test device

FIG. 7 shows the side view of the cross section on a test device

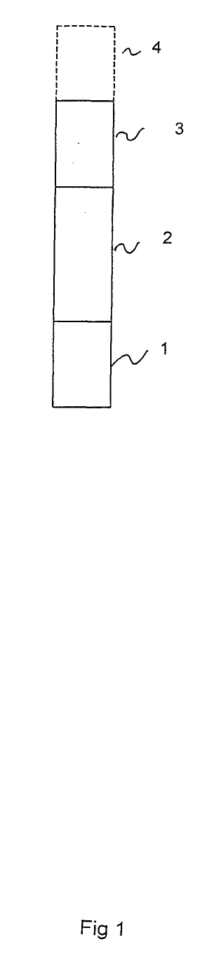

### DETAILED DESCRIPTION OF THE INVENTION

An ‘analyte’ is the compound or composition to be detected or measured in the liquid test sample. The analyte of interest may be for example a protein, a peptide, an amino acid, a nucleic acid, a hormone, a steroid, a vitamin, a natural or chemical substance, a contaminant, a drug including antibiotics or drugs of abuse, such as heroin, LSD, cocaine, morphine, ecstasy, marijuana. The analyte may be a sugar such as glucose.

In general, the test strip will comprise a transport material which is able to transport the liquid from the sample receiving zone to the indication zone. Advantageously absorbing or chromatographic materials can be used. Examples of materials which may be used are paper, nitrocellulose and porous polymers. Preferably the liquid transport material will be supported by a solid material such as plastic like PVC or PE.

The dimension of the test strip may vary. In general the length will be greater than the width, for example at least three times, preferably five times, more preferably seven times, even more preferably ten times greater than the width. The liquid transport material may be a single or a plurality of materials, as long each of the zones is in liquid contact with the adjacent zone.

The sample-receiving zone (1), receives the liquid test sample and the wetting of the test strip will start. The receiving of the test sample will continue until at least some of the test sample (including the analyte) is transported from the sample-receiving zone to the reaction zone (2) and subsequently to the indication zone (3). In one embodiment of the present invention, filtration means can be present. This filtration means may be a separate material placed before the sample-receiving zone. This filtration means can be used to remove compounds or particles present in the liquid test sample and which might interfere with the liquid transport through the test strip or the binding or reaction in the reaction or indication zone. Advantageously such a filtration means is mounted on top of the sample-receiving zone of the test strip.

In another embodiment of the present invention after the indication zone, an extra absorbing zone (4) may be advantageously present. This absorbing zone is advantageous applied in case the flow of the analytes or labelled receptor is much lower than the flow of the liquid sample in the test strip and/or in cases where only of very low amounts of analytes to be tested are present in the liquid sample.

In general in the reaction zone the analyte, which enters the receiving zone and which is transported to the indication zone, will be converted (for example labelled) into a compound or form which is directly or indirectly detectable in the indication zone. ‘Converted’ means that a chemical or physical reaction or coupling may take place. Directly means that analyte, which might be converted, is detected. Indirectly means that active ingredients present on the reaction zone which are intended for the chemical or physical reaction or coupling with the analyte, and which are not reacted or coupled, are detected.

According to one embodiment of the invention in the reaction zone a labelled receptor analyte may be present. The transport zone allows the transport of the analyte and/or the labelled receptor which may or may not be bound to the analyte to the indication zone.

The labelled receptor can be any compound which is capable of binding with the analyte, for example, monoclonal or polyclonal antibody or may be another binding biochemical, microbial or chemical substance or reagent which might bind to the analyte. In cases where an antibody is used either whole antibodies or fragments thereof may be employed. Single chain antibodies, chimeric antibodies, or CDR-grafted antibodies may also be employed. Binding may take place through chemical or physical binding.

In the indication zone the labelled receptor, free of analyte, can be bound on a control zone present in the indication zone. Upon binding, the control zone changes to a signal that can be detected for example a signal visible to the eye. A test zone present in the indication zone may bind the labelled receptor coupled to analyte. Here a less intense colour (compared to the control zone) indicates that the analyte is not present in a sufficient amount (negative result). In case the test zone is equal or more intense than the control zone a high amount of analyte is present (positive result).

According to another embodiment of the invention, in the reaction zone a labelled component is present which can bind to a receptor present in reaction or indication zone. The labelled component competes for binding with the unlabelled analyte in the sample.

The unlabelled receptor can be any compound which is capable of binding with the analyte, for example, monoclonal or polyclonal antibodies, or may be any other biochemical, microbial or chemical structure substance or reagent which might bind to the analyte. The sample may be a fluid such as urine, blood, milk, meat juice or pathological samples. The test sample is generally a liquid. In some embodiments a liquid test sample may be prepared by dissolving a solid or gas into an appropriate liquid.

The above mentioned examples of the use of the test strip to detect an analyte are given to illustrate the present invention. The invention is not limited to these examples. The skilled person will appreciate that other binding and detection mechanisms or means are possible.

‘Label’ is any substance which is attached to or part of the receptor and which is capable of producing a signal that is detectable by visual or instrumental means. Direct visible labels are preferred. Examples thereof include colloidal metallic (for example gold) and non metallic (for example coloured latex) particles and dye particles. Labels may also be generated enzymatically or an enzyme.

According to a preferred embodiment at least two test strips (6 and 7; 6′ and 7′) which are positioned parallel to each other are present in the test device (5 and 5′). In this way it is possible to detect in one test device the presence or absence of more than two analytes. Embodiments of the invention include devices where at least three, four, five, seven or at least ten strips are present, preferably in parallel.

Advantageously, the transport material of the test strips, when multiple strips are present, is not in liquid contact with each other, optionally except for the sample receiving zone (8, 8′ and 8″).

According to one embodiment the transport material of the multiple strips have enough distance from each other to prevent liquid flow from one strip to another, whereas the transport materials are supported on one common support means. Therefore one support means together with several lanes of transport material may form the multiple test strips.

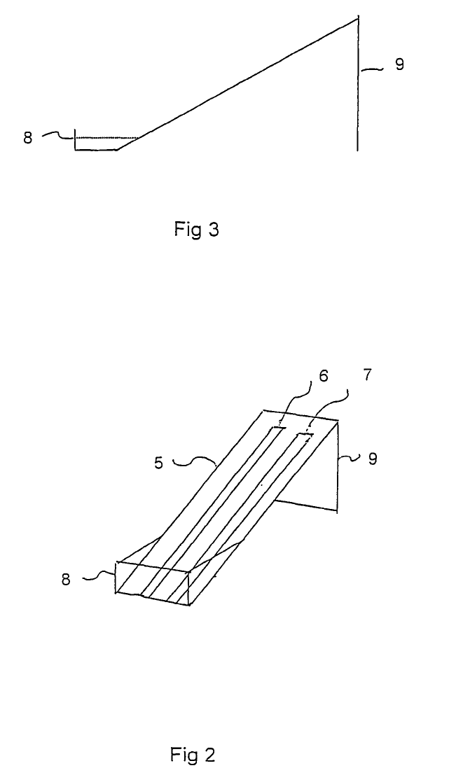

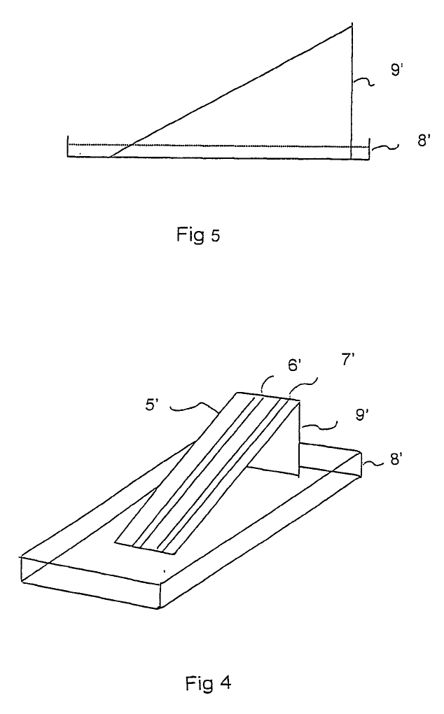

According to another embodiment separate test strips are linked to each other together in such a way that they do not have liquid contact with each other and whereby the indication zones of each strip are still visible. For example the test strips are fixed (for example glued) parallel in a common basis, or the test strips are sealed in parallel position between two foils. To a further preferred embodiment the support means for the test strips and the sample receiving means are dimensioned in such a way that they form together in one part the test holder (FIGS. 2, 3).In this case test holder will be made from one material for example a plastic like polyethylene. The test holder will therefore comprise the support of the test strip and the liquid receiving means and optionally a distance holder.

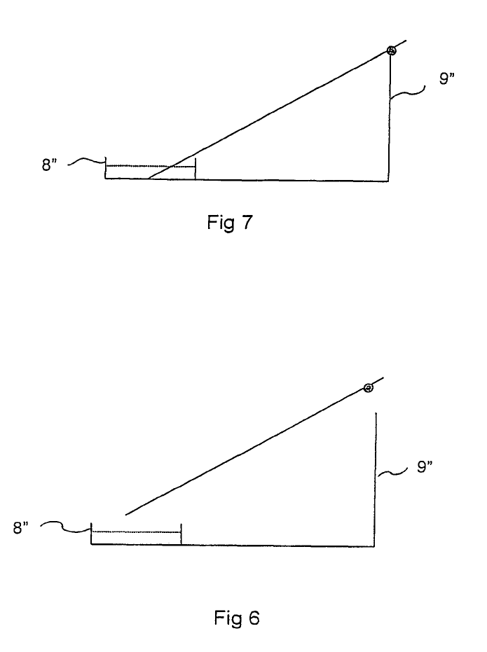

In a preferred embodiment the distance holder (9″) forms together with the sample receiving means (8″) one part (FIGS. 6, 7). According to this embodiment this one part can be re-used whereas only the at least one test strip is replaced for the next test process.

In one embodiment of the invention the reaction and indication zones are a single zone, typically these embodiments will involve situations where the ‘label’ is generated or only becomes detectable in the presence of the analyte to be detected.

An important aspect of the invention is the angle of from 10 to 90° of the test strip with the horizontal. Preferably this angle is from 15 to 70°, more preferably from 20 to 60°. According to one embodiment this angle is obtained by using a distance holder (9, 9′ and 9″) which is placed at the bottom side of the test strip on the opposite side of the sample receiving zone. This distance holder may be of any material. In case the test strip support and holder form one part, the material may be chosen the same. The distance holder may also be a separate means which is connected with the test strip before use.

The liquid receiving means is constructed in such a way that it may contain a predetermined amount of liquid. According to a preferred embodiment of the invention the height (8, 8′ and 8″) of the liquid means determines the amount of liquid test sample. For example a height of from 1 mm to 50 mm, preferably from 1 mm to 25 mm and even more preferably 1 mm to 10 mm is chosen. Preferably enough liquid samples are added to the liquid receiving means to substantially fill this means. In case more liquid sample would be added, the liquid sample would overflow. In this way it is possible to limit the maximum amount of the liquid test sample in the sample receiving means. Advantageous this height and the position of the reaction zone of the test strip are chosen in such a way that when the sample receiving zone of the test strip is in liquid contact with the sample receiving means, the maximum liquid level in the sample receiving means is below the reaction zone of the test strip.

The test strips which comprise the liquid transporting material may absorb water from the air, especially under storage conditions in humid surroundings. This absorption might negatively influence the transport behaviour of the test sample in the test strip and might also interfere with the compounds present in the reaction and indication zone.

Therefore, in general desiccants are used to keep the test strip dry during storage. In a preferred embodiment of the present invention the at least one test strip is sealed in foil which prevents the possible absorption of water from the air. This foil is removed before the test strip is used for testing a liquid sample.

The present invention also provides a kit comprising:

test strip(s) according to the invention;

sample receiving means according to the invention; and

packaging.

The test-strip(s) and sample receiving means may be assembled together or be separate in the kit. In the latter case means for assembling the two such as glue may also be provided.

The kit may also comprise one or more of:

a distance holder according to the invention;

solution for diluting the sample if appropriate;

a positive control comprising a solution containing a known amount of the analyte being tested for;

a negative control comprising a solution which does not contain the analyte to be tested for;

instructions for using the test-device of the invention;

means for detecting the binding of the analyte to the receptor if this is not visually detectable;

a colour chart for analysing the charge, if any, in the indication zone.

The test-device of the invention may be used to detect disease conditions, susceptibility to disease conditions or drug or alcohol. For example, the devices may be used to detect glucose in urine or blood to detect diabetes or to monitor the blood sugar level of a diabetic in order that they know when to inject insulin or modify their sugar intake. The test-device of the invention may provide qualitative, quantitative or semi-quantitative results. The indication zone may change colour if the analyte is present and such colour change may be qualitative, semi-qualitative or quantitative. Alternatively, some other property of the indication zone may change in the presence of the analyte. Serial dilutions may be used to help render the device more quantitative.

The change in the properties of the indication zone may be compared to results obtained using standard solutions containing a known concentration of the analyte to be tested for. In some embodiments the colour change, if any, of the indication zone may be measured against a colour chart indicating the expected colour change for known concentrations of analyte. The change in the indication zone may be measured by eye or using a machine. The use of a machine to use the test-device of the invention and analyse the results may increase sample throughout.

The test-device may be used to detect the presence, absence or amount of infectious agents such as viruses and bacteria or of toxins derived from such agents such as tetanus toxin. The devices may also be used to monitor for environmental pollutants.

1. A test device for determining the presence, absence or amount of an analyte in a liquid test sample which comprises:
I at least one teststrip comprising at least:
a sample receiving zone;
a reaction zone; and,
an indication zone,
the teststrip comprising a material which makes transport of the analyte from the sample receiving zone, preferably via the reaction zone, to the indication zone, possible and in which, the analyte, if present, is directly or indirectly detectable in the indication zone; and
II a sample receiving means which is in functional connection with the sample receiving zone of the teststrip, so that when the liquid sample is added to the receiving means the liquid sample is in liquid contact with the sample receiving zone and the sample receiving means will receive no more liquid than a predetermined quantity,
wherein when the device is placed on a horizontal plane the teststrip makes an angle of from 10 to 90° with the horizontal plane.

2. A test device according to claim 1, wherein the sample receiving zone is present at the lower part of the teststrip.

3. A test device according to claim 1 or 2, comprising at least two teststrips which are positioned parallel to each other.

4. A test device according to any one of the preceding claims wherein the reaction zone and detection zone of the teststrip are situated above the level of the liquid sample when the liquid sample is added to the sample receiving means.

5. A test device according to any one of the preceding claims wherein:
the reaction zone comprises a receptor capable of binding the analyte, if present, the binding of the receptor to the analyte being detectable by direct or indirect means; and/or
the analyte if present is converted in the reaction zone to a detectable form.

6. A test device according to any one of the preceding claims wherein the reaction zone and indication zone are the same zone.

7. A kit comprising:
a teststrip as defined in any one of the preceding claims;
a sample receiving means as defined in any one of the preceding claims; and
packaging.

8. Use of a test device according to any one of claims 1 to 6 or a kit according to claim 7 to determine the presence, absence or amount of an analyte.

9. A method for detecting the presence, absence or amount of an analyte in a liquid test sample, comprising:
adding the test sample to the sample receiving means of a test-device according to any one of claims 1 to 6;
identifying, and optionally quantifying, any detectable change in the indication zone of the test-strip of the device.

10. Use according to claim 8, or a method according to claim 9, wherein the presence or absence of the analyte is indicative of a particular disease state, susceptibility to a particular disease state or of drug or alcohol abuse.
